(19) United States
(12) Patent Application Publication
(10) Pub. No.: US 2024/0305653 A1
(43) Pub. Date: Sep. 12, 2024

(54) CONTROLS FOR CLOUD COMPUTING ENVIRONMENT

(71) Applicant: Wells Fargo Bank, N.A., San Francisco, CA (US)

(72) Inventors: Rachel Bierner, Los Angeles, CA (US); Anthony Concolino, Danbury, CT (US); Mona S. Patel, Huntersville, NC (US); John G. Wagner, III, Reston, VA (US)

(21) Appl. No.: 18/595,743

(22) Filed: Mar. 5, 2024

Related U.S. Application Data
(60) Provisional application No. 63/488,798, filed on Mar. 7, 2023.

(51) Int. Cl. H04L 9/40

(52) U.S. Cl. CPC H04L 63/1416

(57) ABSTRACT

An example computer system for implementing controls for a cloud computing environment can include: one or more processors; and non-transitory computer-readable storage media encoding instructions which, when executed by the one or more processors, causes the computer system to create: a repository engine programmed to consolidate the controls for the cloud computing environment; a workload engine programmed to determine an applicability of the controls to data stored in the cloud computing environment; an adherence validation engine programmed to validate compliance of the controls of the cloud computing environment with the control requirements; a security risk engine programmed to assess security risks associated with the cloud computing environment; and an adherence monitoring engine programmed to continuously monitor compliance of the cloud computing environment with the control requirements and measure changes to the security risks.

### BACKGROUND

The migration of application workloads and data from local processors and storage to the cloud is inevitable as the need for accessibility and flexibility increases in the networked world. However, when workloads are processed and data is stored in the cloud, the owner of the workloads and data can lose some control over how the systems, workloads, and data are protected and maintained. This can increase the risk of workload availability and data loss and make security more difficult.

### SUMMARY

Examples provided herein are directed to controls for workloads and data stored in a cloud computing environment.

According to one aspect, an example computer system for implementing controls for a cloud computing environment can include: one or more processors; and non-transitory computer-readable storage media encoding instructions which, when executed by the one or more processors, causes the computer system to create: a repository engine programmed to consolidate the controls for the cloud computing environment; a workload engine programmed to determine an applicability of the controls to data stored in the cloud computing environment; an adherence validation engine programmed to validate compliance of the controls of the cloud computing environment with the control requirements; a security risk engine programmed to assess security risks associated with the cloud computing environment; and an adherence monitoring engine programmed to continuously monitor compliance of the cloud computing environment with the control requirements and measure changes to the security risks.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for controlling workloads and data stored in a cloud computing environment.

FIG. 2 shows example logical components of a computing device of the system of FIG. 1.

FIG. 3 shows an example user interface of the computing device of FIG. 2.

FIG. 4 shows another example user interface of the computing device of FIG. 2.

FIG. 5 shows another example user interface of the computing device of FIG. 2.

FIG. 6 shows another example user interface of the computing device of FIG. 2.

FIG. 7 shows another example user interface of the computing device of FIG. 2.

FIGS. 8A and 8B show another example user interface of the computing device of FIG. 2.

FIG. 9 shows example physical components of the computing device of FIG. 2.

### DETAILED DESCRIPTION

This disclosure relates to controls for workloads and data stored in a cloud computing environment.

Workloads not processed and data not stored in a local computing environment of an enterprise can be in a cloud computing environment. This cloud computing environment can include workloads and data storage that is managed by one or more third parties and is accessible through a network. There can be various advantages associated with the use of the cloud computing environment for workload processing and data storage, including cost, accessibility, and/or scalability.

Various controls can be applied for workload processing and data stored in the cloud computing environment. These controls can be associated with business and security rules established by the enterprise and/or by regulatory agencies associated with the enterprise.

There can be various advantages associated with the technologies described herein. For instance, various practical applications can be realized through the application of these controls to the cloud computing environment, including data security, fidelity, and/or reliability.

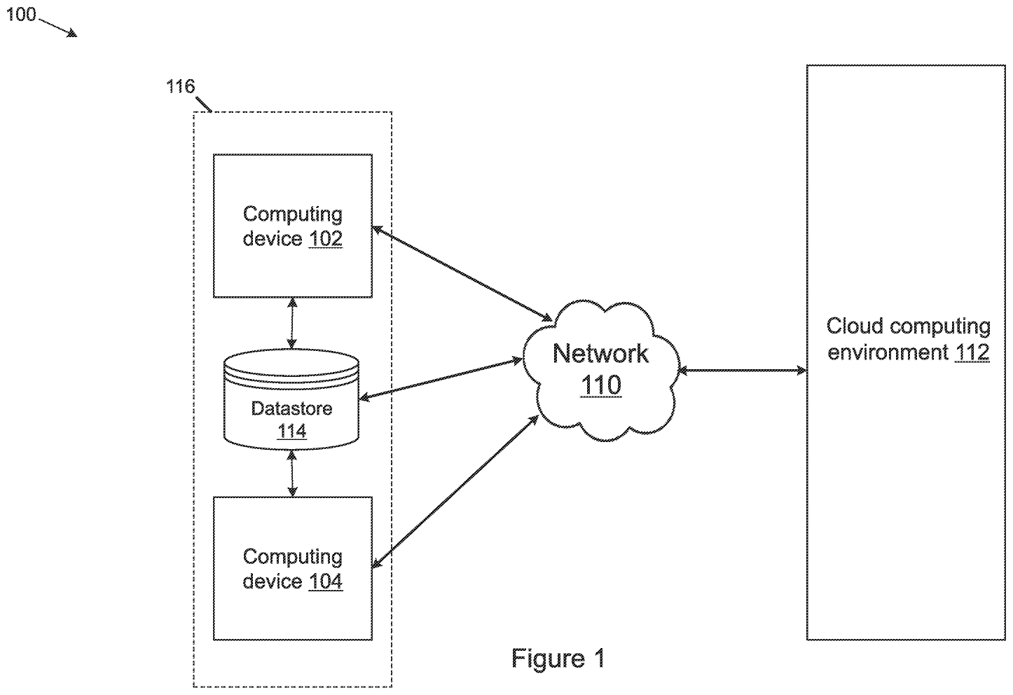

FIG. 1 schematically shows aspects of one example system 100 programmed to provide controls for workload processing and data stored in a cloud computing environment. In this example, the system 100 can include a plurality of client and server devices.

In this instance, the system 100 includes a local computing environment 116 and a cloud computing environment 112. The local computing environment 116 includes computing devices 102, 104 and a datastore 114. The computing devices 102, 104 and the cloud computing environment 112 can communicate through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the local computing environment 116 is owned by a financial institution, such as a bank. The example computing devices 102, 104 are programmed to communicate with the datastore 114 to access business applications and/or data associated with the system 100. For instance, the computing devices 102, 104 can access the datastore 114 to process workloads and/or request data associated with such financial services.

The example datastore 114 is programmed to store information about the system 100. In this example, the datastore 114 is stored locally (e.g., “on premise”) within the local computing environment 116.

The network 110 provides a wired and/or wireless connection between the computing devices 102, 104 and the cloud computing environment 112. In some examples, the network 110 can be a local area network, a wide area network, the Internet, or a mixture thereof. Many different communication protocols can be used.

Although only a few devices are shown, the system 100 can accommodate hundreds or thousands of computing devices. For instance, it is likely that the cloud computing environment 112 includes hundreds or thousands of computing devices that provide reliable data access in accordance with industry standards. Many configurations are possible.

In the depicted example, some or all of the applications and/or data for the local computing environment 116 is stored in the cloud computing environment 112 (e.g., “off premise”). This can, but need not, include a migration of data from the datastore 114 to the cloud computing environment 112 for access by the computing devices 102, 104. For instance, data that is traditionally stored locally in the datastore 114 can be transitioned for storage in the cloud computing environment 112.

Similarly, as new applications and data are developed, the new applications and/or the data associated with the new applications is likewise stored in the cloud computing environment 112, rather than being stored locally (e.g., within the datastore 114). For instance, as the computing devices 102, 104 provide the functionality associated with the enterprise (as described above), the computing devices 102, 104 access the cloud computing environment to obtain and store data.

Examples of cloud computing environments include, without limitation: GCP Cloud Native Solutions provided by Google; Azure Cloud Native Solutions provided by Microsoft; and Amazon Web Services from Amazon. Although a single cloud computing environment is shown in the system 100, in other embodiments, the system 100 can access multiple different cloud computing environments.

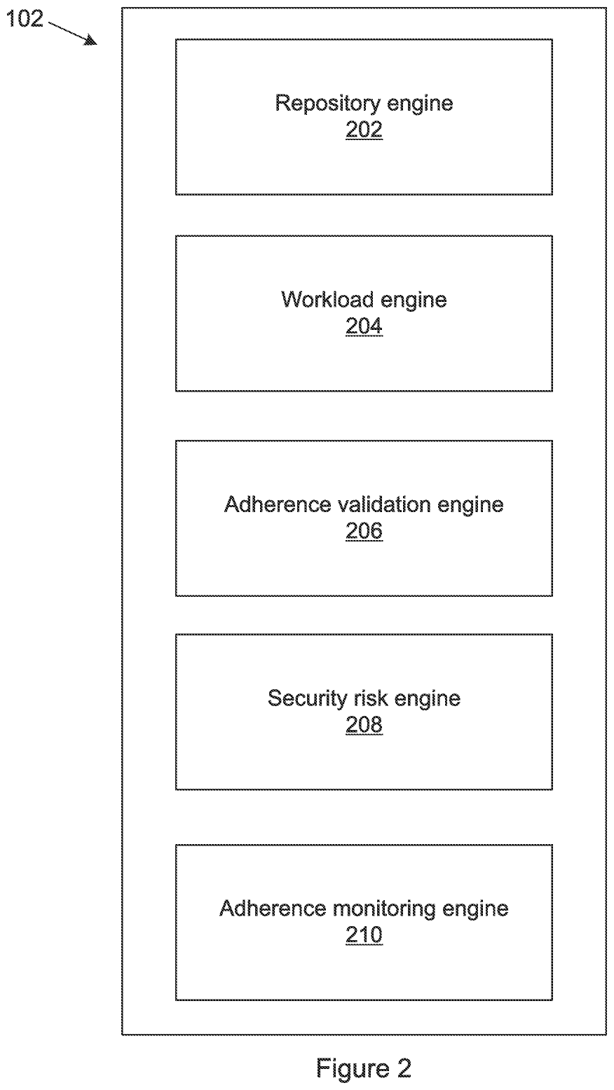

Referring now to FIG. 2, additional details of the computing device 102 are shown. In this example, the computing device 102 has various logical modules that can be programmed to provide controls for data stored in the cloud computing environment 112. In this example, the computing device 102 is programmed to access information from the datastore 114 and the cloud computing environment 112 and apply appropriate controls thereto. In one instance, the computing device 102 uses application programming interface calls to the datastore 114 and the cloud computing environment 112 to access information that is necessary for the proper application of the controls to the cloud computing environment 112.

In this example, the computing device 102 includes a repository engine 202, a workload engine 204, an adherence validation engine 206, a security risk engine 208, and an adherence monitoring engine 210. In other examples, more or fewer logical modules can be provided.

In this example, the repository engine 202 is programmed to consolidate all controls for cloud computing environments. The repository engine 202 is a centralized datastore for those controls and is kept current and aligned with authoritative sources (e.g., regulations, industry frameworks), internal policies, threat intelligence and business strategies. In this example, the repository engine 202 provides the controls to other logical modules of the computing device 102 for use in conducting risk analysis, predictive analytics, etc. for the cloud computing environment 112.

The controls can be directed at various aspects associated with the cloud computing environment 112. In some examples, the controls are directed at the infrastructure that makes up the cloud computing environment 112, the software applications that make up the cloud computing environment 112, and/or the services provided by the cloud computing environment 112.

For instance, one example control relates to the use of cryptographic keys. The control requires enablement of automatic key rotation for cryptographic keys. In another example control, access to cloud management consoles is limited to appropriate groups of individuals within a defined support team. These are just two of the many tens, hundreds, or thousands of controls that may be applicable to workload and data that is stored in the cloud computing environment 112.

The example workload engine 204 is programmed to automatically determine the applicability of the controls for the specific data that is being stored and accessed in the cloud computing environment 112. For instance, the workload engine 204 can determine the type of data being stored and the type of applications that are accessing the data. For instance, the data can be classified based upon a type (e.g., confidential, restricted, public, etc.), and controls are applied based upon the classification. Based upon this determination, the workload engine 204 can access the appropriate controls from the repository engine 202 to apply to that data.

In this example, the workload engine 204 only applies those controls that are applicable to the data at issue. For instance, the workload engine 204 can determine the applicable controls based upon blueprints, workload characteristics, and controls inherited from the data at issue.

In this manner, the monitoring and alerting associated with the applied controls is managed so that the number of alerts provided by the computing device 102 is reduced. In other words, the workload engine 204 is programmed to only apply applicable controls, thereby reducing alerts from controls that do not apply to specific data. This helps to reduce noise and increase scalability for the system 100.

As illustrated, the adherence validation engine 206 is programmed to validate compliance with the required controls for the data stored in the cloud computing environment 112. For instance, the adherence validation engine 206 is configured to access data from the datastore 114 and the cloud computing environment 112 to correlate the data and assure that appropriate controls are applied.

In some examples, the adherence validation engine 206 provides an auditable process that accesses data in near real-time so that the controls are applied to live (rather than stale) data in the cloud computing environment 112. This helps to assure that objectives associated with the controls are achieved.

In this example, the security risk engine 208 is programmed to use the data from the adherence validation engine 206 to access security risks associated with the data in the cloud computing environment 112. The security risk engine 208 can automatically provide an aggregate view of risk, compensating controls, and residual risk. For instance, a first control may indicate that certain types of access are higher risk, while a second control may indicate that such access is more secure when done through encryption. The combination of controls may bring the aggregate risk below a relevant threshold.

Further, the security risk engine 208 can be programmed to determine risks based upon the controls used for particular data in the cloud computing environment 112, in other words the type of data. The security risk engine 208 can identify a threshold (or a combination of thresholds when multiple controls apply) and provide alerts when the security risk exceeds the threshold(s). Further, the security risk engine 208 can aggregate the risk potentials to identify “toxic combination”, or risk that are acceptable on their own but, when combined, result in a combination that exceeds a desired threshold of risk.

Finally, the example adherence monitoring engine 210 is programmed to determine the efficient and effective identification of risk and proper alerting for the entire system 100. For instance, the adherence monitoring engine 210 can continuously monitor for “drift” associated with controls as the data stored in the cloud computing environment 112 evolves and the cloud computing environment 112 itself changes. As this drift moves the cloud computing environment 112 out of compliance with one or more controls, the adherence monitoring engine 210 alerts to this issue.

Drift can be manifest as any deviation from an approved security baseline. For example, drift could involve turning off multifactor authentication for certain access when required by a control. In another example, drift could include a secure storage bucket being made publicly accessible in contravention of a control. Finally, drift could include resources created outside of authorized containers when a control requires them to reside within those containers. Many other examples of drift are possible.

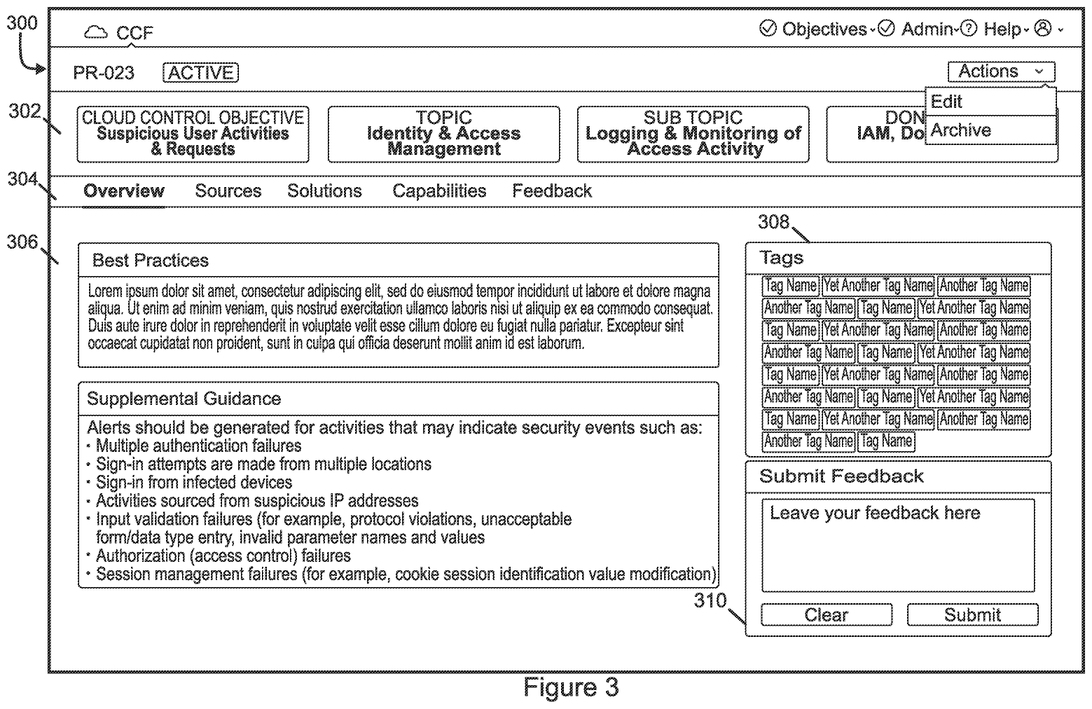

Referring now to FIGS. 3-7, an example interface 300 is shown. The interface 300 can be generated by the computing device 102 for access to information associated with the controls applied to the cloud computing environment 112.

In FIG. 3, the interface 300 includes a header portion 302 that lists basic information about the subject matter displayed on the interface 300. In this instance, the subject matter relates to control topics on suspicious user activities and requests, and the topic (identity and access management)/subtopic (logging and monitoring of access activity)/domain (identity and access management domain) are identified in the header portion 302.

A menu portion 304 of the interface 300 provides access to various tabs of the interface 300 with information related to the selected control topic. In FIG. 3, an overview tab is selected. The overview tab includes an information portion 306 with best practices and supplemental guidance associated with the selected control topic. The overview tab also includes a tags portion 308 with tags that are used to identify the selected control topic. Finally, the overview tab includes a feedback portion 310 that allows the user to submit feedback relating to the selected control topic.

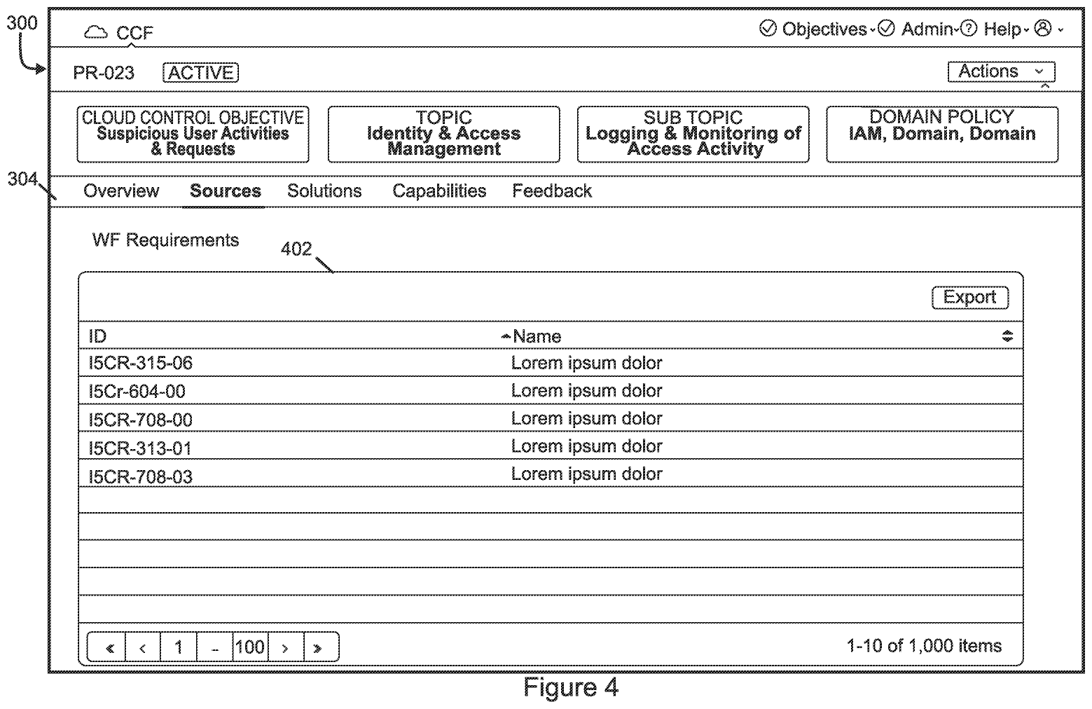

Referring now to FIG. 4, a sources tab of the menu portion 304 of the interface 300 is selected. The sources tab includes a table 402 listing all the controls associated with the selected control topic. This can include the identifier and name associated with each of the controls listed in the table 402. Further, each of the controls can provide a link to more information associated with the controls when selected by the user.

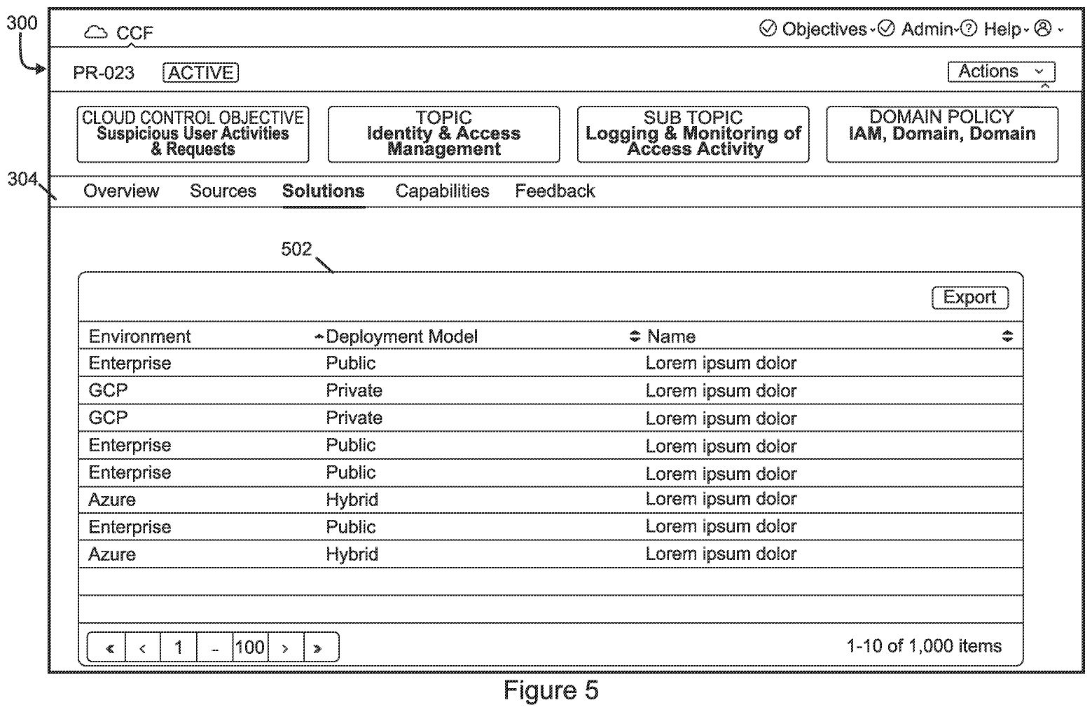

Referring now to FIG. 5, a solutions tab of the menu portion 304 of the interface 300 is selected. The solutions tab includes a table 502 listing all control solutions provided for particular environments associated with the control topic. In this example, the environment, deployment model, and name of cach control solution is provided.

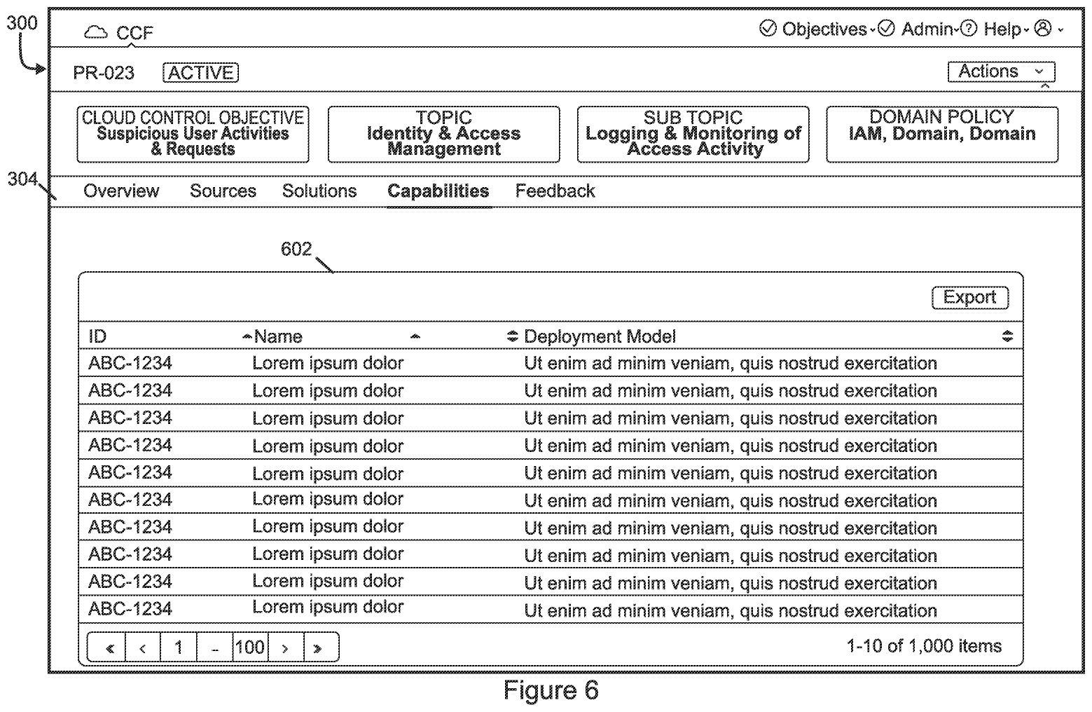

Referring now to FIG. 6, a capabilities tab of the menu portion 304 of the interface 300 is selected. The capabilities tab includes a table 602 listing the capabilities associated with the selected control topic. In this example, the identifier, name, and description of cach capability is provided.

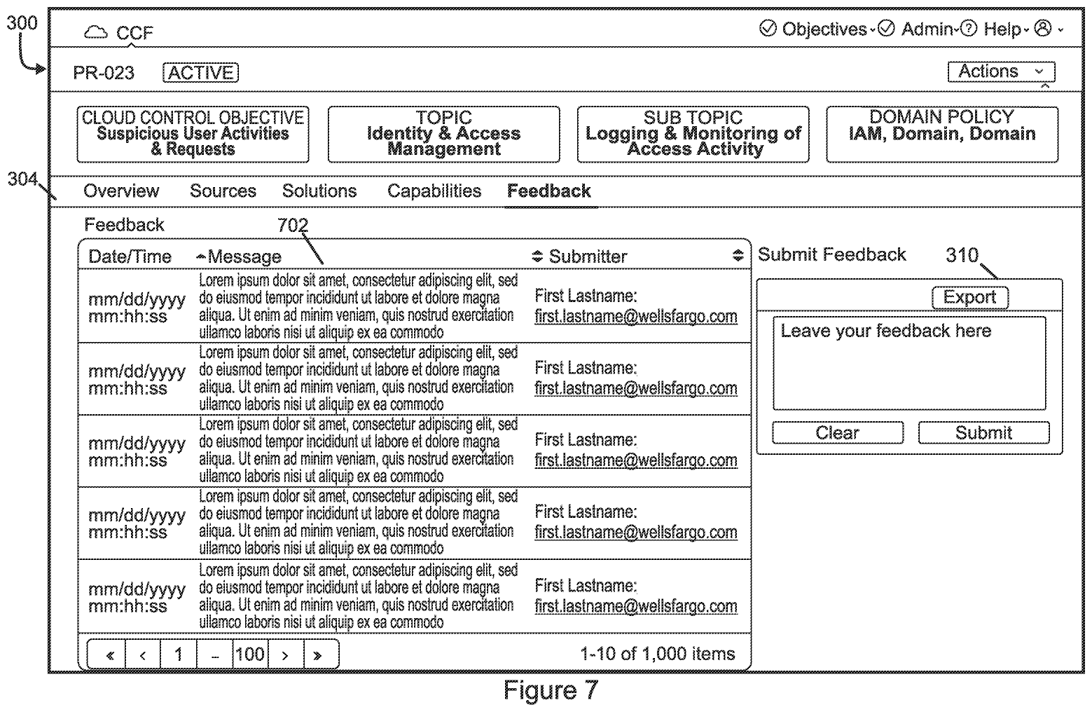

Referring now to FIG. 7, a feedback tab of the menu portion 304 of the interface 300 is selected. In this example, the feedback tab includes a table 702 listing all the feedback submitted for the selected control topic. This includes time, message, and submitter information associated with each feedback received by the interface 300 on the selected control topic.

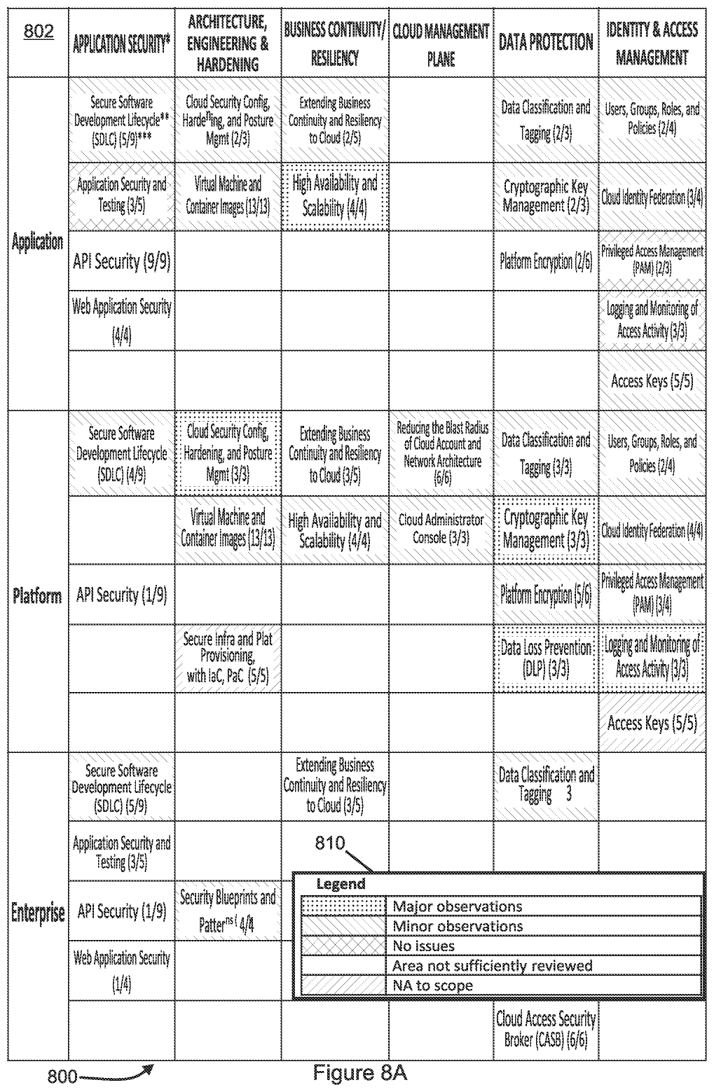

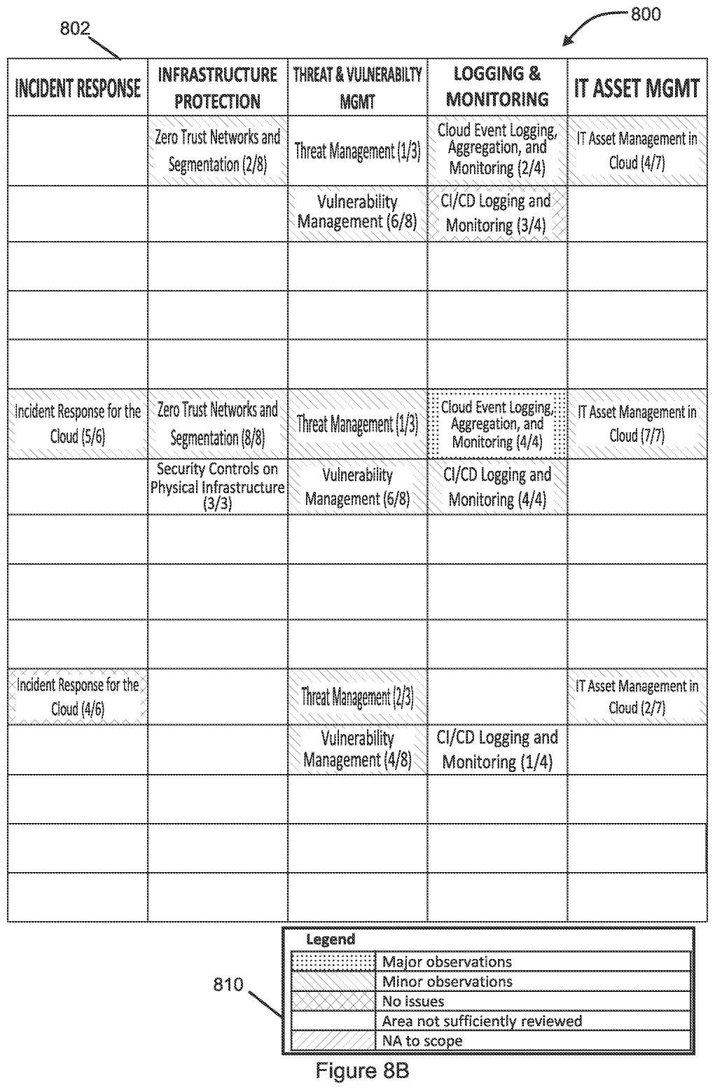

Referring now to FIGS. 8A and 8B, another example interface 800 of the computing device 102 is shown. In this example, the interface 800 provides a heat map 802 of the controls for the cloud computing environment 112. In this example, the heat map 802 includes different aspects of the cloud computing environment 112 on the vertical axis (e.g., application, platform, enterprise) and different control topics on the horizontal axis (e.g., application security, architecture, business continuity, etc.).

Relevant controls are placed on the heat map 802 and are coded based upon a legend 810. For instance, controls having no issues are colored green, while controls with minor issues are colored yellow, and controls with major issues are colored red. In this manner, the user can visually determine areas where controls are sufficient (e.g., areas of green) and areas where controls are insufficient (e.g., areas of red) using the heat map 802. Many other manners of conveying this type of information are possible.

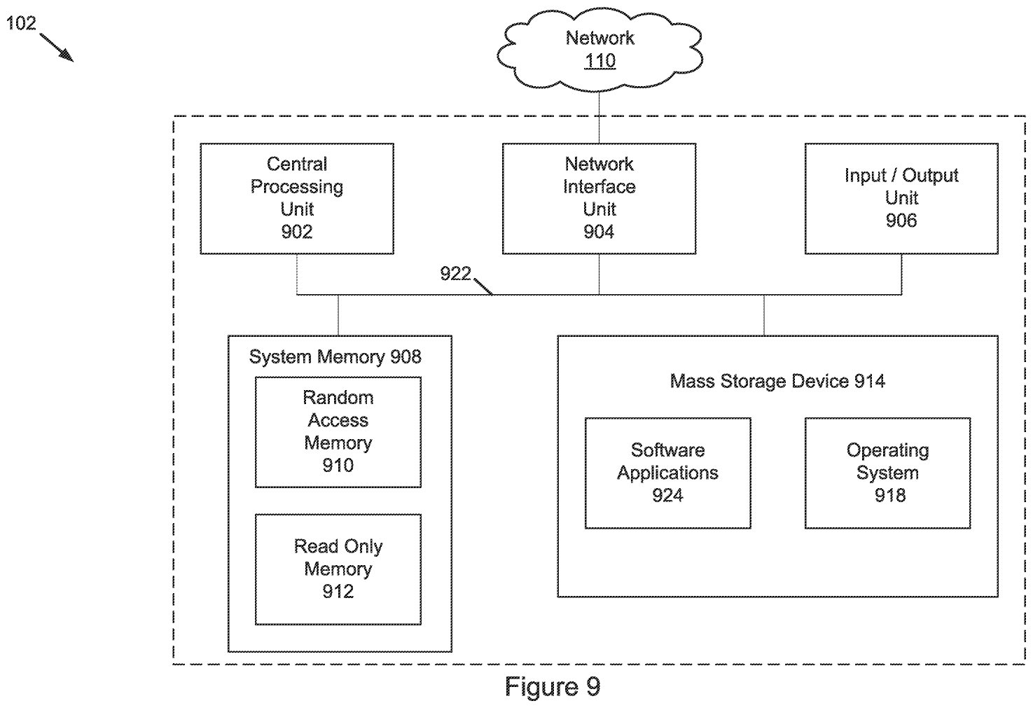

As illustrated in the embodiment of FIG. 9, the example computing device 102, which provides the functionality described herein, can include at least one central processing unit (“CPU”) 902, a system memory 908, and a system bus 922 that couples the system memory 908 to the CPU 902. The system memory 908 includes a random-access memory (“RAM”) 910 and a read-only memory (“ROM”) 912. A basic input/output system containing the basic routines that help transfer information between elements within the computing device 102, such as during startup, is stored in the ROM 912. The computing device 102 further includes a mass storage device 914. The mass storage device 914 can store software instructions and data. A central processing unit, system memory, and mass storage device similar to that shown can also be included in the other computing devices disclosed herein.

The mass storage device 914 is connected to the CPU 902 through a mass storage controller (not shown) connected to the system bus 922. The mass storage device 914 and its associated computer-readable data storage media provide non-volatile, non-transitory storage for the computing device 102. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 102.

According to various embodiments of the invention, the computing device 102 may operate in a networked environment using logical connections to remote network devices through network 110, such as a wireless network, the Internet, or another type of network. The computing device 102 may connect to network 110 through a network interface unit 904 connected to the system bus 922. It should be appreciated that the network interface unit 904 may also be utilized to connect to other types of networks and remote computing systems. The computing device 102 also includes an input/output controller 906 for receiving and processing input from a number of other devices, including a touch user interface display screen or another type of input device. Similarly, the input/output controller 906 may provide output to a touch user interface display screen or other output devices.

As mentioned briefly above, the mass storage device 914 and the RAM 910 of the computing device 102 can store software instructions and data. The software instructions include an operating system 918 suitable for controlling the operation of the computing device 102. The mass storage device 914 and/or the RAM 910 also store software instructions and applications 924, that when executed by the CPU 902, cause the computing device 102 to provide the functionality of the computing device 102 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for implementing controls for a cloud computing environment, comprising:
one or more processors; and
non-transitory computer-readable storage media encoding instructions which, when executed by the one or more processors, causes the computer system to create:
a repository engine programmed to consolidate the controls for the cloud computing environment;
a workload engine programmed to determine an applicability of the controls to workload processing and data stored in the cloud computing environment;
an adherence validation engine programmed to validate compliance with the controls of the cloud computing environment;
a security risk engine programmed to assess security risks associated with the workload processing and the data stored in the cloud computing environment; and
an adherence monitoring engine programmed to monitor compliance of the cloud computing environment with the controls and measure changes to the security risks.

2. The computer system of claim 1, wherein the repository engine is a centralized repository of the controls.

3. The computer system of claim 1, wherein the repository engine is further programmed to keep the controls current.

4. The computer system of claim 1, wherein the workload engine is further programmed to select the controls based upon a type of data being stored and other relevant attributes in the cloud computing environment.

5. The computer system of claim 1, wherein the workload engine is further programmed to minimize false alerts associated with the controls.

6. The computer system of claim 1, wherein the adherence validation engine is further programmed to correlate the data from the cloud computing environment with a local datastore.

7. The computer system of claim 1, wherein the adherence validation engine is further programmed to audit the data in the cloud computing environment in near real-time.

8. The computer system of claim 1, wherein the security risk engine is further programmed to automatically calculate an aggregated risk associated with the data in the cloud computing environment.

9. The computer system of claim 1, wherein the security risk engine is further programmed to compare the security risks to a threshold to determine appropriate alerting.

10. The computer system of claim 1, wherein the adherence monitoring engine is further programmed to manage drift associated with the cloud computing environment.

11. A method for implementing controls for a cloud computing environment, the method comprising:
consolidating the controls for the cloud computing environment;
determining an applicability of the controls to workload processing and data stored in the cloud computing environment;
validating compliance with the controls of the cloud computing environment;
assessing security risks associated with the workload processing and the data stored in the cloud computing environment; and
monitoring compliance of the cloud computing environment with the controls and measure changes to the security risks.

12. The method of claim 11, further comprising providing a centralized repository of the controls.

13. The method of claim 11, further comprising keeping the controls current.

14. The method of claim 11, further comprising selecting the controls based upon a type of data being stored and other relevant attributes in the cloud computing environment.

15. The method of claim 11, further comprising minimizing false alerts associated with the controls.

16. The method of claim 11, further comprising correlating the data from the cloud computing environment with a local datastore.

17. The method of claim 11, further comprising auditing the data in the cloud computing environment in near real-time.

18. The method of claim 11, further comprising automatically calculating an aggregated risk associated with the data in the cloud computing environment.

19. The method of claim 11, further comprising comparing the security risks to a threshold to determine appropriate alerting.

20. The method of claim 11, further comprising managing drift associated with the cloud computing environment.
